(19) United States
(12) Patent Application Publication
(10) Pub. No.: US 2012/0092576 A1
(43) Pub. Date: Apr. 19, 2012

(54) LIQUID CRYSTAL DISPLAY ELEMENT AND DEVICE

(75) Inventor: Masaki NOSE, Kawasaki (JP)

(73) Assignee: FUJITSU LIMITED, Kawasaki-shi (JP)

(21) Appl. No.: 13/277,193

(22) Filed: Oct. 19, 2011

(30) Foreign Application Priority Data
Oct. 19, 2010 (JP) 2010-234611

(51) Int. Cl. G02F 1/1343

(52) U.S. Cl. 349/33; 349/139

(57) ABSTRACT

A liquid crystal display element includes a first and a second liquid crystal layer stacked on each other. The first liquid crystal layer includes a first liquid crystal strip group and a second liquid crystal strip group extending in a first direction and alternately aligned. A first electrode group and a second electrode group are disposed so as to hold the first liquid crystal strip group and the second liquid crystal strip group therebetween. The second liquid crystal layer includes a third liquid crystal strip group and a fourth liquid crystal strip group extending in a second direction orthogonal to the first direction and alternately aligned. A third electrode group and a fourth electrode group are disposed so as to hold the third liquid crystal strip group and the fourth liquid crystal strip group therebetween. Each electrode group includes electrodes extending in the each direction substantially parallel to each other.

### CROSS-REFERENCE TO RELATED APPLICATION

This application is based upon and claims the benefit of priority of the prior Japanese Patent Application No. 2010-234611 filed on Oct. 19, 2010, the entire contents of which are incorporated herein by reference.

### FIELD

The present invention relates to a liquid crystal display element and a liquid crystal display device.

### BACKGROUND

In recent years, there has been significant progress in techniques for maintaining electronic paper display without a power source and electrically rewriting display contents. Electronic paper is expected to offer such advantages as ultra-low power consumption that enables display contents of a memory to be displayed even when power is disconnected, a reflection type display that prevents eye fatigue, and a thin and flexible display element similar a paper sheet. Accordingly, the use of the electronic paper is spreading in the form of electronic books, electronic newspapers, electronic posters and the like. Types of display currently under development include an electrophoretic display that drives charged particles to migrate in air or a liquid, a twist ball display that rotates charged particles each having two different colors, an organic EL display, and a selective-reflection-type cholesteric liquid crystal display that utilizes interference reflection of a liquid crystal layer, which offers high bistability.

Among the foregoing display types, the cholesteric liquid crystal display is superior in terms of memory function, power consumption, colorization and so forth. In particular, the cholesteric liquid crystal display is by far superior in terms of color display. In the other modes than the cholesteric liquid crystal display, a color filter including three different color portions has to be provided on each pixel, and hence maximum obtainable brightness is one third, which is practically unusable. In contrast, the cholesteric liquid crystal display utilizes interference between liquid crystals to reflect a color, which enables a color to be displayed simply by stacking the liquid crystals, with the advantage in that brightness close to or over 50% may be achieved.

Cholesteric liquid crystal, also referred to as chiral nematic liquid crystal, is formed by adding a relatively large amount (tens of percent) of chiral additive to a nematic liquid crystal, so that the molecules of the nematic liquid crystal form a helical cholesteric phase. The cholesteric liquid crystal is controlled on the basis of the alignment status of the liquid crystal molecules, for performing a display. References to the foregoing technique may be found, for example, in Japanese Laid-open Patent Publications Nos. 6-059271, 9-068702, and 2001-242315.

### SUMMARY

According to an aspect of an embodiment, a liquid crystal display element includes a first liquid crystal layer and second liquid crystal layer stacked on each other; wherein the first liquid crystal layer includes a first liquid crystal strip group and a second liquid crystal strip group extending in a first direction and alternately aligned, and a first electrode group and a second electrode group disposed so as to hold the first liquid crystal strip group and the second liquid crystal strip group therebetween; the second liquid crystal layer includes a third liquid crystal strip group and a fourth liquid crystal strip group extending in a second direction orthogonal to the first direction and alternately aligned, and a third electrode group and a fourth electrode group disposed so as to hold the third liquid crystal strip group and the fourth liquid crystal strip group therebetween; the first electrode group includes a plurality of first electrodes extending in the first direction substantially parallel to each other; the second electrode group includes a plurality of second electrodes extending in the second direction substantially parallel to each other; the third electrode group includes a plurality of third electrodes extending in the first direction substantially parallel to each other; and the fourth electrode group includes a plurality of fourth electrodes extending in the second direction substantially parallel to each other.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are diagrams for explaining a status of a cholesteric liquid crystal according to a comparative example.

FIG. 2 is a schematic cross-sectional view of a reflective color liquid crystal display element including a trilayer cholesteric liquid crystal according to the comparative example.

FIG. 3 is a graph showing a reflection characteristic of an RGB panel according to the comparative example, in a planar state.

FIGS. 4A and 4B are a plan view and a cross-sectional view respectively, showing the RGB panel according to the comparative example.

FIGS. 5A and 5B are plan views of a reflective color liquid crystal display element having a simple matrix type bilayer structure according to the comparative example, and FIG. 5C is a cross-sectional view thereof.

FIG. 6 is a schematic drawing showing how liquid crystal strips overlap in the layered structure according to the comparative example.

FIGS. 7A and 7B are plan views of a panel constituting a reflective color liquid crystal display element according to a first embodiment of the present invention.

FIG. 8 is a cross-sectional view of the reflective color liquid crystal display element according to the first embodiment, in which a first layer panel and a second layer panel are stacked.

FIG. 9 is a schematic drawing showing subpixels forming one pixel according to the first embodiment.

FIGS. 10A to 10C are schematic diagrams showing examples of liquid crystal color combination to be loaded in each liquid crystal strip according to the first embodiment.

FIGS. 11A to 11P are schematic diagrams for explaining color display by one pixel in which four subpixels are in a planar state and a focal conic state, according to the first embodiment.

FIGS. 12A and 12B are plan views of a panel implementing a reflective color liquid crystal display element according to a second embodiment of the present invention.

FIG. 13 is a schematic diagram showing colors of subpixels forming one pixel and colors displayed by that pixel, according to the second embodiment.

FIGS. 14A and 14B are plan views of a panel implementing a reflective color liquid crystal display element according to a third embodiment of the present invention.

FIG. 15 is a schematic diagram showing colors of subpixels forming one pixel and colors displayed by that pixel, according to the third embodiment.

FIGS. 16A to 16H are schematic diagrams showing color display examples according to the third embodiment.

FIGS. 17A and 17B are plan views of a panel implementing a reflective color liquid crystal display element according to a fourth embodiment, and FIG. 17C is a cross-sectional view of the stacked panels.

FIGS. 18A to 18C are schematic diagrams showing colors of subpixels forming one pixel and colors displayed by that pixel, according to the third embodiment.

FIG. 19 is a block diagram showing a general configuration of a reflective color liquid crystal display device including the reflective color liquid crystal display element according to one of the first to the fourth embodiment.

### DESCRIPTION OF EMBODIMENTS

First, a comparative example with respect to the present invention will be described referring to the drawings.

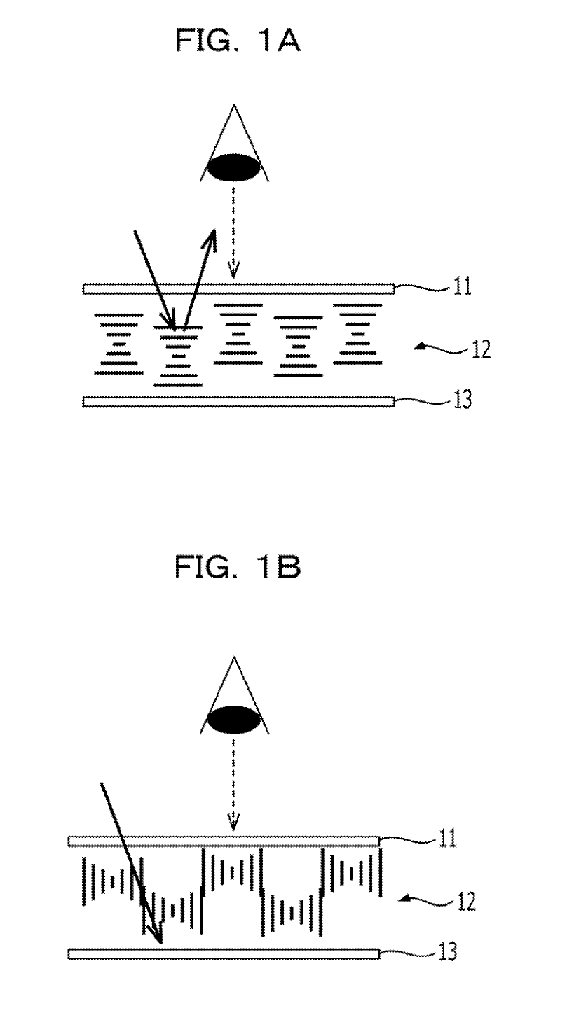

FIGS. 1A and 1B are diagrams for explaining a status of a cholesteric liquid crystal. As shown therein, a display element 10 including the cholesteric liquid crystal includes an upper substrate 11, a cholesteric liquid crystal layer 12, and a lower substrate 13. The cholesteric liquid crystal assumes a planar state that reflects an incident light as shown in FIG. 1A, and a focal conic state that transmits an incident light as shown in FIG. 1B, both of which are stably maintained even under a field-free condition. The cholesteric liquid crystal may also assume a homeotropic state that appears upon applying an intense electric field such that all liquid crystal molecules are aligned in the direction of the electric field, however the homeotropic state turns to the planar or focal conic state by stopping applying the electric field.

In the planar state, the cholesteric liquid crystal reflects a light of a wavelength determined in accordance with a helical pitch of the liquid crystal molecules. A wavelength 2, that makes the reflection maximal may be defined as the following equation, in which n represents the mean refractive index of the liquid crystal, and p represents the helical pitch thereof.

Λ=n·p

Meanwhile, a reflection band Δλ increases with an increase in refractive anisotropy Δn of the liquid crystal.

In the planar state the incident light is reflected, and hence a bright state, i.e., a white color may be displayed. In the focal conic state, a light transmitted through the liquid crystal layer may be absorbed by a light absorption layer provided under the lower substrate 13, and hence a dark state, i.e., a black color may be displayed. In addition, the liquid crystal molecules in the planar state and those in the focal conic state may be mixed, in which case a middle tone may be displayed, and gradation of the middle tone is determined by a mixture ratio of the liquid crystal molecules in the planar state and those in the focal conic state.

Methods currently known for controlling the cholesteric liquid crystal include a conventional driving method which is simple to operate. An intense electric field is applied so as to create a homeotropic state, then the electric field is suddenly cancelled so as to create the planar state, which displays the bright state. To turn the bright state to the dark state, a relatively weak electric field is applied to the planar state for a short period of time. The level of the dark state, in other words the gradation of the middle tone is determined by the voltage or pulse width of the applied electric field. A dynamic driving scheme (DDS) is another example of the controlling method.

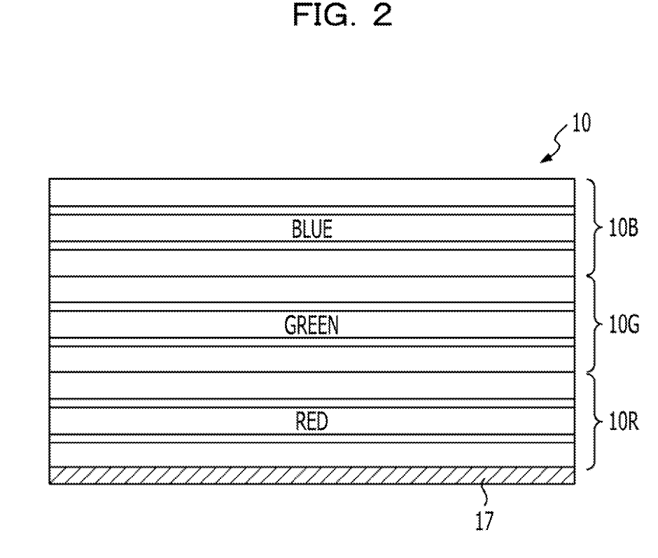

FIG. 2 is a schematic cross-sectional view of a reflective color liquid crystal display element including three cholesteric liquid crystal layers. As shown therein, the display element 10 includes three layers of panels, which are a blue panel 10B, a green panel 10G, and a red panel 10R from the top, and a light absorption layer 17 is provided under the red panel 10R. The panels 10B, 10G, and 10R have substantially the same structure, however the liquid crystal material and the chiral material, as well as the content of the chiral material are differently determined such that a reflection center wavelength of the panel 10B becomes blue (approx. 480 nm), that of the panel 10G becomes green (approx. 550 nm), and that of the panel 10R becomes red (approx. 630 nm). Scan electrodes and data electrodes of the panels 10B, 10G, and 10R are driven by a common driver 28 and a segment driver 29. The panels 10B, 10G, and 10R have substantially the same structure except for the reflection center wavelength.

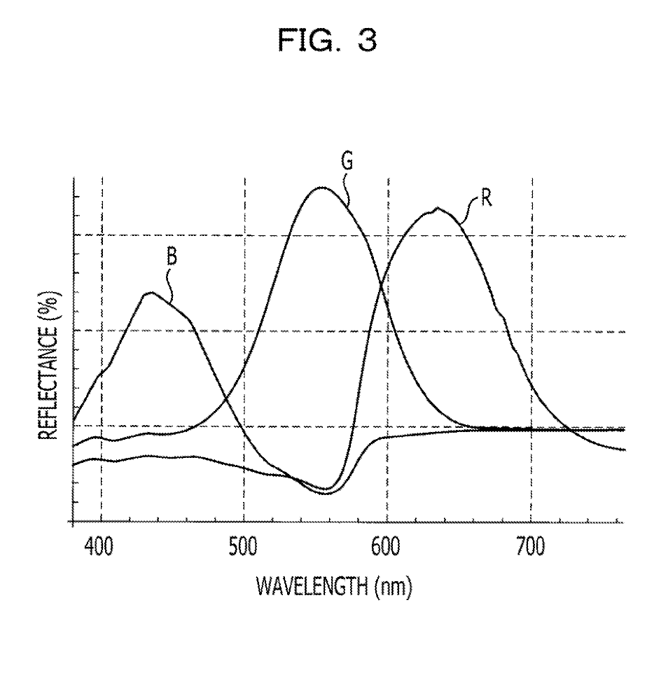

FIG. 3 is a graph showing a reflection characteristic of the panels 10B, 10G, and 10R in the planar state, in which B represents the reflection characteristic of the panel 10B, G represents that of the panel 10G, and R represents that of the panel 10R.

In the case where the panel 10B is in the planar state and the panels 10G and 10R are in the focal conic state, blue (B) is displayed. In the case where the panel 10G is in the planar state and the panels 10B and 10R are in the focal conic state, green (G) is displayed. In the case where the panel 10R is in the planar state and the panels 10B and 10G are in the focal conic state, red (R) is displayed. In the case where all of the panels 10B, 10G, and 10R are in the planar state white (W) is displayed, and in the case where all of the panels 10B, 10G, and 10R are in the focal conic state black is displayed. Hereinafter, black will be represented by “F”.

As stated above, the panels 10B, 10G, and 10R have substantially the same structure except for the reflection center wavelength. FIGS. 4A and 4B are a plan view and a cross-sectional view respectively, showing a basic structure of the panels 10B, 10G, and 10R.

As shown in FIG. 4A, the display element 10A includes the upper substrate 11, a plurality of upper electrodes 14 aligned substantially parallel to each other on the surface of the upper substrate 11, the lower substrate 13, a plurality of lower electrodes 15 aligned substantially parallel to each other on the surface of the lower substrate 13, and a seal member 16. The upper substrate 11 and the lower substrate 13 are disposed such that the electrodes 14 and 15 oppose each other, and a liquid crystal layer 12 is provided therebetween in which cholesteric liquid crystal is loaded, and the liquid crystal layer 12 is sealed with the seal member 16. Although not shown, a spacer is provided in the liquid crystal layer 12. The upper electrodes 14 and the lower electrodes 15 are disposed orthogonal to each other in plan view, and an intersection corresponds to one pixel. A voltage pulse signal is applied to the upper electrodes 14 and the lower electrodes 15, so that a voltage is applied to the liquid crystal layer 12. The voltage thus applied to the liquid crystal layer 12 brings the liquid crystal molecules in the liquid crystal layer 12 to the planar state or focal conic state, so that a display is realized. Although both the upper substrate 11 and the lower substrate 13 are light-transmissive, the lower substrate 13 of the panel 10R may be non-transmissive.

Since the upper electrodes 14 and the lower electrodes 15 of the panels 10B, 10G, and 10R are disposed so as to overlap in plan view, pixels of the three layers overlap so as to perform an RGB color display, and controlling the middle tone gradation with respect to each pixel leads to an RGB full-color display.

The cholesteric liquid crystal display element and driving methods thereof are well known, and therefore further description will be skipped.

As stated above, the cholesteric liquid crystal display device employs the trilayer structure as shown in FIG. 2, for performing the color display, however it is preferable to reduce the number of layers in order to reduce the cost. To realize a color display with two or fewer layers, one of the layers has to include a plurality of liquid crystal portions that each reflects a different color. The plurality of liquid crystal portions are isolated from each other by a partition. A minimum conceivable structure is a single layer structure including the three (RGB) liquid crystal portions divided by partitions, however the single layer structure is unable to provide sufficient brightness, and therefore a bilayer structure has been focused on.

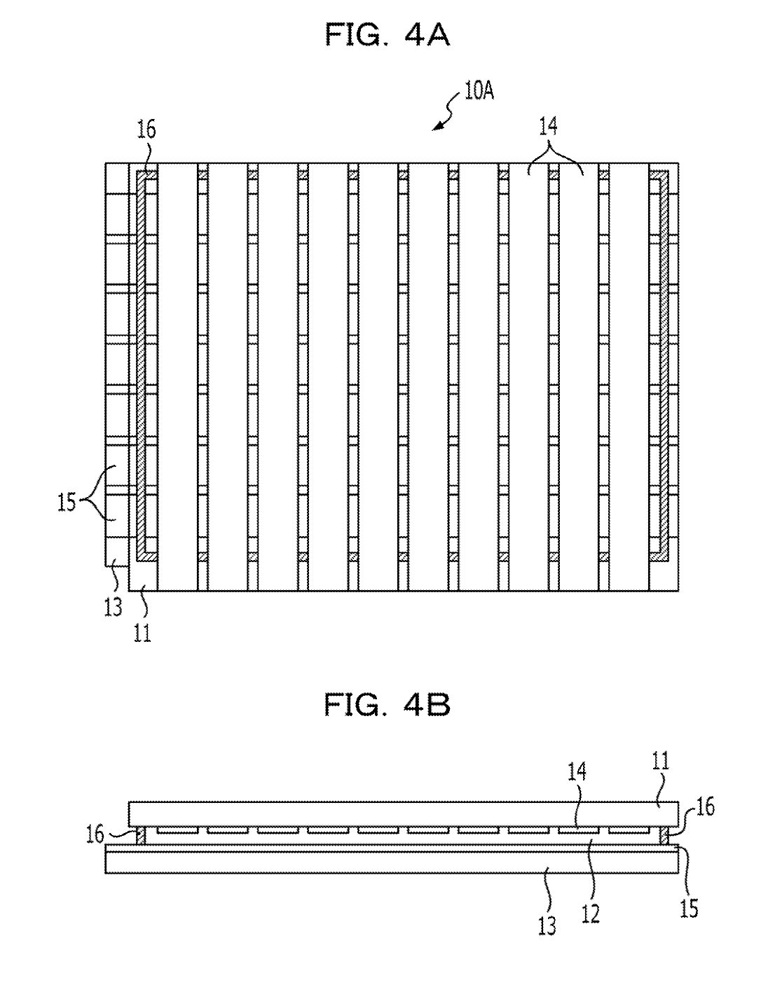

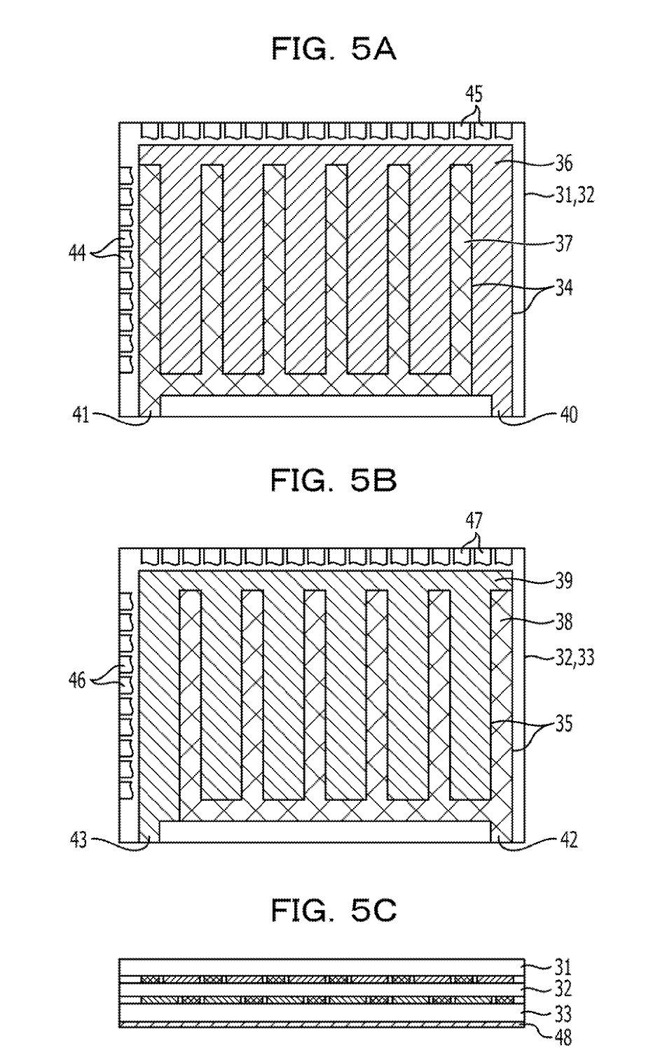

FIGS. 5A to 5C depict a simple matrix type bilayer structure, FIG. 5A showing a structure of a first layer, FIG. 5B showing a structure of a second layer, and FIG. 5C showing a cross-section of the bilayer structure.

First, the structure of the first layer will be described. As shown in FIG. 5A, a plurality of transparent electrodes 44 and 45 respectively aligned substantially parallel to each other are provided on opposing surfaces of transparent substrates 31 and 32. The transparent electrodes 44 extend in a first direction, and the transparent electrodes 45 extend in a second direction. The transparent electrodes 44 and 45 are disposed orthogonal to each other in plan view. Between the transparent substrates 31 and 32, on which the transparent electrodes 44 and 45 are respectively provided, a partition 34 is provided so as to define a plurality of first liquid crystal strips 36 and a plurality of second liquid crystal strips 37, extending in the second direction and alternately aligned. The first liquid crystal strips 36 are approximately twice as wide as the second liquid crystal strips 37. The first liquid crystal strips 36 are disposed so as to overlap with two transparent electrodes 45, and the second liquid crystal strips 37 are disposed so as to overlap with one transparent electrode 45. The plurality of first liquid crystal strips 36 communicate with each other and liquid crystal may be supplied thereinto through a liquid crystal inlet 40. Likewise, the plurality of second liquid crystal strips 37 communicate with each other and liquid crystal may be supplied thereinto through a liquid crystal inlet 41. Upon supplying two types of cholesteric liquid crystal that reflect different colors into the plurality of first liquid crystal strips 36 and the plurality of second liquid crystal strips 37 respectively, a single layer structure that may display two colors may be obtained. In this single layer structure, the liquid crystal located at intersections of the transparent electrodes 44 and the transparent electrodes 45 may be controlled, and one of such intersection corresponds to one subpixel, as will be subsequently described.

As shown in FIG. 5B, the second layer is configured similarly to the first layer. By supplying two types of cholesteric liquid crystal that reflect different colors respectively into a plurality of third liquid crystal strips 38 and a plurality of second liquid crystal strips 39 defined by a partition 35, a single layer structure that may display two colors may be obtained. In this single layer structure also, an intersection of a transparent electrode 46 and a transparent electrode 47 corresponds to one subpixel.

Referring to FIG. 5C, the transparent substrate 32 serving as the lower substrate of the first layer also serves as the upper substrate of the second layer. A light absorption layer 48 is provided under the transparent substrate 33 serving as a lower substrate of the second layer.

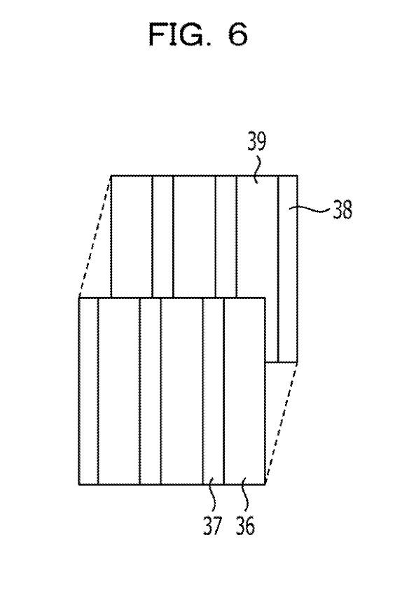

FIG. 6 illustrates how the four liquid crystal strips, namely the first liquid crystal strips 36, the second liquid crystal strips 37, the third liquid crystal strips 38, and the fourth liquid crystal strips 39, overlap in the bilayer structure shown in FIG. 5C. The second liquid crystal strips 37 and the third liquid crystal strips 38, both of which are narrow, are deviated from each other, and therefore three types of liquid crystal strips are formed where the first liquid crystal strip 36 and the third liquid crystal strip 38 overlap, where the first liquid crystal strip 36 and the fourth liquid crystal strip 39 overlap, and where the second liquid crystal strip 37 and the fourth liquid crystal strip 39 overlap, respectively. In the example shown in FIGS. 5A to 5C, three subpixels included in three adjacent liquid crystal strips implement one pixel. In other words, three subpixels located at positions where three adjacent transparent electrodes 45 and three transparent electrodes 47 overlapping therewith intersect with one transparent electrode 44 and one transparent electrode 46 overlapping therewith implement one pixel. More accurately, the three subpixels in the first layer and the three subpixels in the second layer, totally six subpixels implement one pixel.

For example, liquid crystal that reflects blue (B) is supplied in the first liquid crystal strips 36, liquid crystal that reflects green (G) is supplied in the second liquid crystal strips 37 and the third liquid crystal strips 38, and liquid crystal that reflects red (R) is supplied in the fourth liquid crystal strips 39. In this case, red (R), green (G), blue (B), cyan (C), magenta (M), yellow (Y), white (W), and black (F) may be displayed by performing an on/off control with respect to the six subpixel in the first layer and the second layer.

In the example shown in FIGS. 5A to 5C and 6, the overlapping two liquid crystal strips extend in substantially the same direction, in other words the partitions extend in substantially the same direction. Accordingly, the partition acts as a stripe noise, making the display visually unpleasant.

It is to be noted that a bilayer liquid crystal display element has been proposed that includes two segment type layers in which upper electrodes and lower electrodes are disposed so as to overlap in substantially the same direction, so that the liquid crystal may be controlled with respect to portions divided in a strip shape. The upper strips and the lower strips are orthogonally stacked, and the liquid crystal display element may be driven as if it were a simple matrix type element. However, this display element allows only the strip-shaped portion to be controlled in one layer, and is therefore unsuitable for performing a color display unlike the simple matrix driving method shown in FIG. 5.

Hereunder, embodiments of the present invention will be described referring to the drawings.

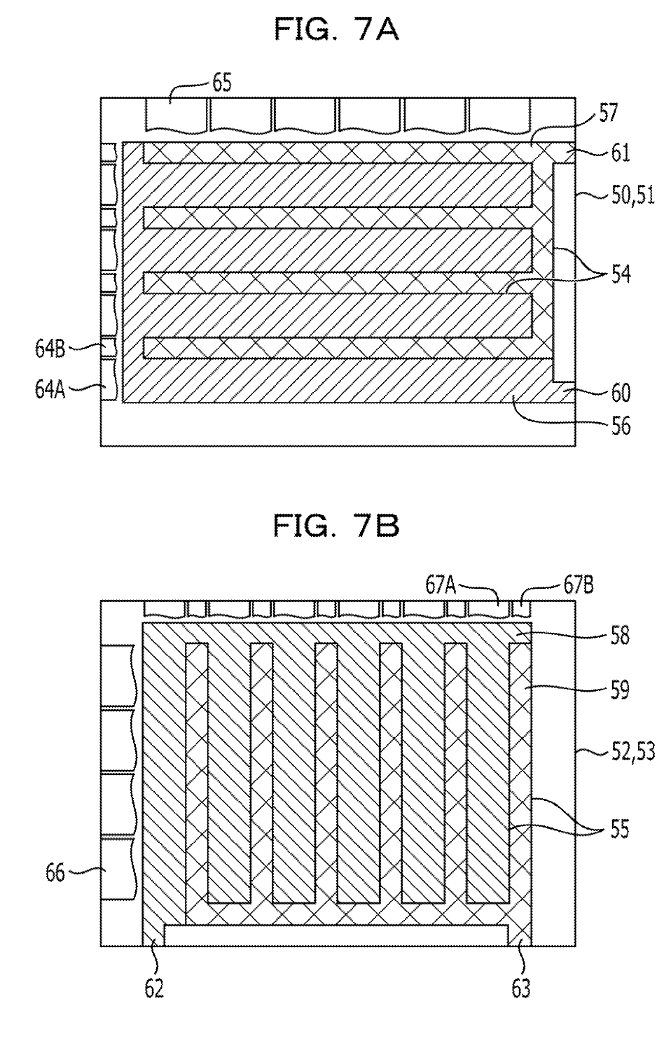

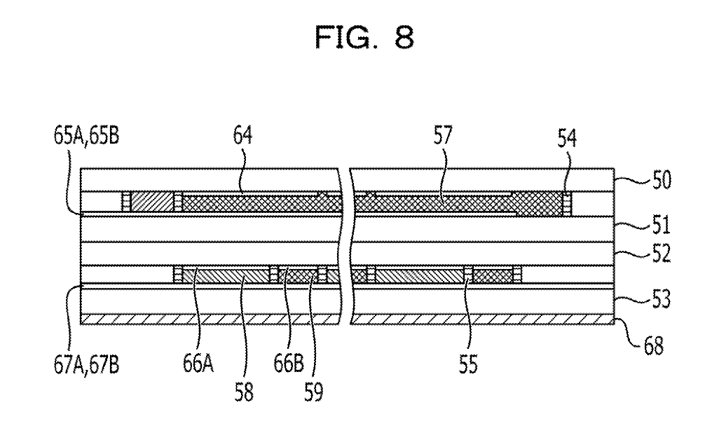

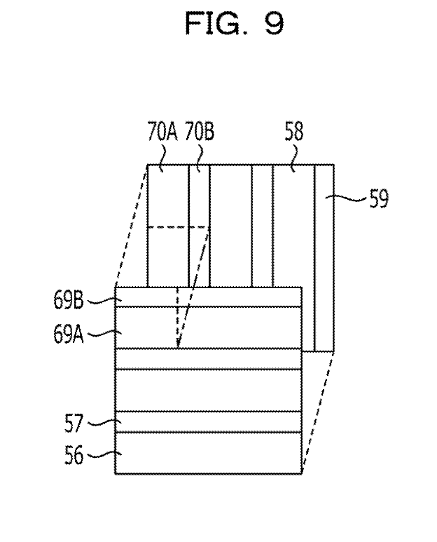

FIGS. 7A and 7B are plan views of a panel implementing a reflective color liquid crystal display element according to a first embodiment, FIG. 7A showing the panel of a first layer, and FIG. 7B showing the panel of a second layer. FIG. 8 is a cross-sectional view of the reflective color liquid crystal display element according to the first embodiment, in which the first layer panel and the second layer panel are stacked. FIG. 9 is a schematic drawing showing subpixels forming one pixel according to the first embodiment.

As shown in FIGS. 7A, 8 and 9, the panel of the first layer includes a transparent substrate 50 on which a plurality of parallelly extending second transparent electrodes 65 are provided, and a transparent substrate 51 on which a plurality of sets of parallelly extending first transparent electrodes 64A and 64B are provided. The transparent substrates 50 and 51 are disposed such that the surfaces thereof with the electrodes oppose each other. The first transparent electrodes 64A and 64B extend in a first direction (horizontally in this example), and are alternately aligned. The second transparent electrodes 65 extend in a second direction (vertically in this example). The first transparent electrode 64A is approximately twice as wide as the first transparent electrode 64B. The second transparent electrode 65 is approximately three times as wide as the first transparent electrode 65B. The plurality of sets of first transparent electrodes 64A, 64B and the plurality of second transparent electrodes 65 are disposed orthogonal to each other in plan view.

A partition 54 is provided between the transparent substrates 50 and 51, so as to define a plurality of first liquid crystal strips 56 and a plurality of second liquid crystal strips 57, extending in the first direction and alternately aligned. The first liquid crystal strips 56 are approximately twice as wide as the second liquid crystal strips 57. The first liquid crystal strips 56 are disposed so as to overlap with the first transparent electrode 64A, and the second liquid crystal strips 57 are disposed so as to overlap with the first transparent electrode 64B. The plurality of first liquid crystal strips 56 communicate with each other and liquid crystal may be supplied thereinto through a liquid crystal inlet 60. Likewise, the plurality of second liquid crystal strips 57 communicate with each other and liquid crystal may be supplied thereinto through a liquid crystal inlet 61. Upon supplying two types of cholesteric liquid crystal that reflect different colors into the plurality of first liquid crystal strips 56 and the plurality of second liquid crystal strips 57 respectively, the panel of the first layer that may display two colors may be obtained. In the first layer panel, a subpixel 69A is formed at the intersection of the first transparent electrodes 64A, the second transparent electrode 65, and a subpixel 69B is formed at the intersection of the first transparent electrode 64B and the second transparent electrode 65. The state of the liquid crystal corresponding to the subpixels 69A and 69B may be controlled, and the subpixels 69A and 69B implement one pixel, as will be subsequently described.

As shown in FIGS. 7A, 8 and 9, the panel of the second layer includes a transparent substrate 52 on which a plurality of sets of parallelly extending fourth transparent electrodes 67A and 67B are provided, and a transparent substrate 53 on which a plurality of parallelly extending third transparent electrodes 66 are provided. The transparent substrates 52 and 53 are disposed such that the surfaces thereof with the electrodes oppose each other. The third transparent electrodes 66 extend in a first direction. The fourth transparent electrodes 67A and 67B extend in a second direction, and are alternately aligned. The fourth transparent electrode 67A is approximately twice as wide as the fourth transparent electrode 67B. The third transparent electrode 66 is approximately three times as wide as the fourth transparent electrode 67B. The plurality of third transparent electrodes 66 and the plurality of sets of fourth transparent electrodes 67A and 67B are disposed orthogonal to each other in plan view.

A partition 55 is provided between the transparent substrates 52 and 53, so as to define a plurality of third liquid crystal strips 58 and a plurality of fourth liquid crystal strips 59, extending in the second direction and alternately aligned. The third liquid crystal strips 58 are approximately twice as wide as the fourth liquid crystal strips 59. The third liquid crystal strips 58 are disposed so as to overlap with the fourth transparent electrode 67A, and the fourth liquid crystal strips 59 are disposed so as to overlap with the fourth transparent electrode 67B. The plurality of third liquid crystal strips 58 communicate with each other and liquid crystal may be supplied thereinto through a liquid crystal inlet 62. Likewise, the plurality of fourth liquid crystal strips 59 communicate with each other and liquid crystal may be supplied thereinto through a liquid crystal inlet 63. Upon supplying two types of cholesteric liquid crystal that reflect different colors into the plurality of third liquid crystal strips 58 and the plurality of fourth liquid crystal strips 59 respectively, the panel of the second layer that may display two colors may be obtained. In the second layer panel, a subpixel 70A (FIG. 9) is formed at the intersection of the third transparent electrode 66 and the fourth transparent electrode 67A, and a subpixel 70B is formed at the intersection of the third transparent electrode 66 and the fourth transparent electrode 67B. The state of the liquid crystal corresponding to the subpixels 70A and 70B may be controlled, and the subpixels 70A and 70B constitute one pixel, as will be subsequently described.

In the first embodiment, the sets of the first transparent electrodes 64A, 64B and the third transparent electrodes 66 are aligned at substantially the same pitch, and the second transparent electrodes 65 and the sets of the fourth transparent electrodes 67A, 67B are aligned at substantially the same pitch. The first layer panel and the second layer panel are coupled in such an orientation that the set of the first electrodes 64A and 64B overlaps with the third electrode 66, and that the second electrode 65 overlaps with the set of the third electrodes 67A and 67B. Alternatively, the lower transparent substrate 51 of the first layer panel and the upper transparent substrate 52 of the second layer panel may be formed in a single common substrate thereby forming a bilayer structure, as shown in FIG. 5C. A light absorption layer 68 is provided under the transparent substrate 53 serving as the lower substrate of the second layer panel.

Although the partitions 54 and 55 serve as a seal member in the reflective color liquid crystal display element according to the first embodiment, a seal member may be additionally provided along a periphery of the liquid crystal layer.

In the reflective color liquid crystal display element according to the first embodiment, the four liquid crystal strips, namely the first liquid crystal strip 56, the second liquid crystal strip 57, the third liquid crystal strip 58 and the fourth liquid crystal strip 59 overlap as shown in FIG. 9, and a portion where the subpixels 69A, 69B and the subpixels 70A, 70B overlap corresponds to one pixel. In other words, four subpixels located at positions where two adjacent first electrodes 64A, 64B and one third electrode 66 overlapping therewith intersect with one second electrode 65 and two adjacent fourth electrodes 67A, 67B overlapping therewith implement one pixel.

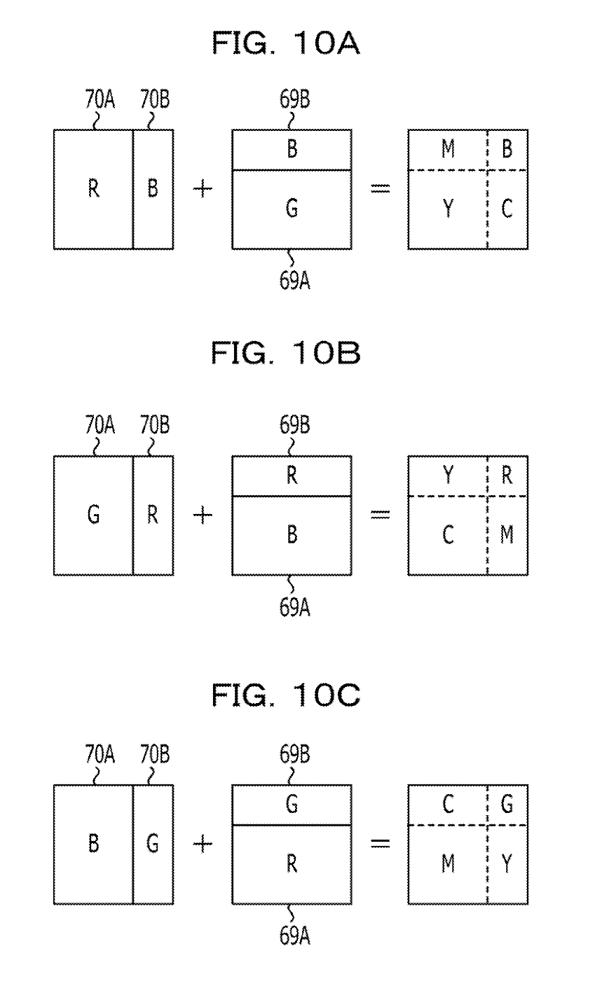

Regarding the type of liquid crystal to be loaded in the respective liquid crystal strips, i.e., in the respective subpixels, various combinations may be adopted. FIGS. 10A to 10C show a few examples, in which left-side boxes represent the subpixels 70A and 70B of the lower panel, central boxes represent the subpixels 69A and 69B of the upper panel, and right-side boxes represent the states of pixels formed by stacking the upper and lower panels. Colors allocated to the subpixels 70A, 70B and the subpixels 69A, 69B in FIGS. 10A to 10C are the colors to be reflected in the planar state. Accordingly, the subpixels 70A, 70B and the subpixels 69A, 69B present the colors reflected in the planar state and black in the focal conic state, in a binary display mode. Also, the colors specified in the stacked subpixels on the right are the colors to be reflected when the subpixels 70A, 70B and the subpixels 69A, 69B are in the planar state.

FIG. 10A illustrates the case where a cholesteric liquid crystal that reflects green (G) is loaded in the first liquid crystal strips 56, a cholesteric liquid crystal that reflects blue (B) is loaded in the second liquid crystal strips 57 and the fourth liquid crystal strips 59, and a cholesteric liquid crystal that reflects red (R) is loaded in the third liquid crystal strips 58. The liquid crystal strips respectively loaded with these RGB cholesteric liquid crystals exhibit, for example, a spectral reflectance shown in FIG. 3. In the case of FIG. 10A, B-liquid crystal and G-liquid crystal are loaded in an area ratio of 1:2 in the upper panel, and B-liquid crystal and R-liquid crystal are loaded in an area ratio of 1:2 in the lower panel. In the case where all of the subpixels 69A, 69B, 70A, and 70B are in the planar state, the overlapping portions of these subpixels exhibit the colors shown in FIG. 10A. Specifically, a portion where the subpixels 70A and 69A overlap is yellow (Y), a portion where the subpixels 70A and 69B overlap is magenta (M), a portion where the subpixels 70B and 69A overlap is cyan (C), and a portion where the subpixels 70B and 69B overlap is blue (B).

FIG. 10B illustrates the case where a cholesteric liquid crystal that reflects blue (B) is loaded in the first liquid crystal strips 56, a cholesteric liquid crystal that reflects red (R) is loaded in the second liquid crystal strips 57 and the fourth liquid crystal strips 59, and a cholesteric liquid crystal that reflects green (G) is loaded in the third liquid crystal strips 58. In the case of FIG. 10B, R-liquid crystal and B-liquid crystal are loaded in an area ratio of 1:2 in the upper panel, and R-liquid crystal and G-liquid crystal are loaded in an area ratio of 1:2 in the lower panel. In the case where all of the subpixels 69A, 69B, 70A, and 70B are in the planar state, the pixel formed by stacking these subpixels exhibits the colors shown in FIG. 10B. Specifically, a portion where the subpixels 70A and 69A overlap is cyan (C), a portion where the subpixels 70A and 69B overlap is yellow (Y), a portion where the subpixels 70B and 69A overlap is magenta (M), and a portion where the subpixels 70B and 69B overlap is red (R).

FIG. 10C illustrates the case where a cholesteric liquid crystal that reflects red (R) is loaded in the first liquid crystal strips 56, a cholesteric liquid crystal that reflects green (G) is loaded in the second liquid crystal strips 57 and the fourth liquid crystal strips 59, and a cholesteric liquid crystal that reflects blue (B) is loaded in the third liquid crystal strips 58. In the case of FIG. 10C, G-liquid crystal and R-liquid crystal are loaded in an area ratio of 1:2 in the upper panel, and G-liquid crystal and B-liquid crystal are loaded in an area ratio of 1:2 in the lower panel. In the case where all of the subpixels 69A, 69B, 70A, and 70B are in the planar state, the pixel formed by stacking these subpixels exhibits the colors shown in FIG. 10C. Specifically, a portion where the subpixels 70A and 69A overlap is magenta (M), a portion where the subpixels 70A and 69B overlap is cyan (C), a portion where the subpixels 70B and 69A overlap is yellow (Y), and a portion where the subpixels 70B and 69B overlap is green (G).

Many different combinations may be adopted, and for example the color combination of the upper and lower panels may be exchanged.

From the viewpoint of visual characteristics, the color combination of FIG. 10A, in which yellow (Y) of a weak tone is given the lowest spatial frequency, in other words implements the largest subpixel, while cyan (C), magenta (M), and blue (B) having an intense tone are given a higher spatial frequency, in other words implement smaller subpixels, provides a highest definition in terms of a white background of a text image and a skin color of a portrait.

In FIG. 10C, magenta (M) is given a low frequency, however since magenta (M) has an intense tone the image appears rough in terms of the white background of a text image and the skin color of a portrait.

Taking such tendencies into account, it is visually preferable to allocate a color of a lower visual impression such as blue (B) to a portion of a narrower pattern width (where the area ratio is 1/3).

Here, a characteristic of visual spatial frequency response is generally the same in horizontal and vertical directions, and therefore the directionality of stripes of diffused partitions is not specifically limited.

Although the color reflections with the subpixels 70A, 70B and the subpixels 69A, 69B in the planar state have been described, the subpixels may assume both the planar state and the focal conic state in a binary display mode, as stated above. Therefore, many other colors may be displayed.

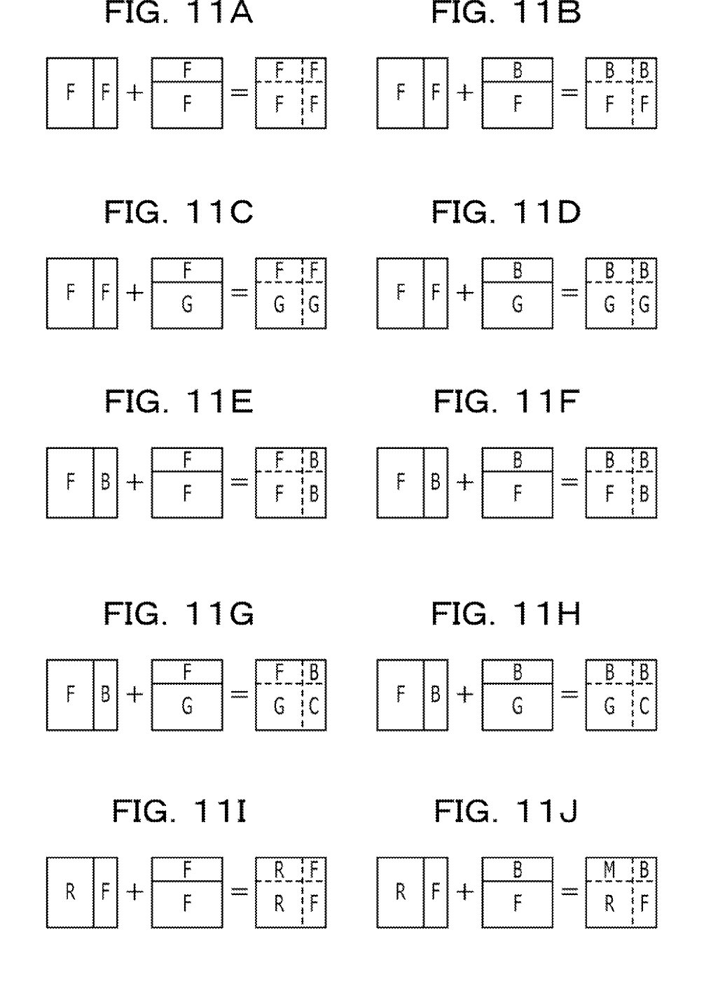

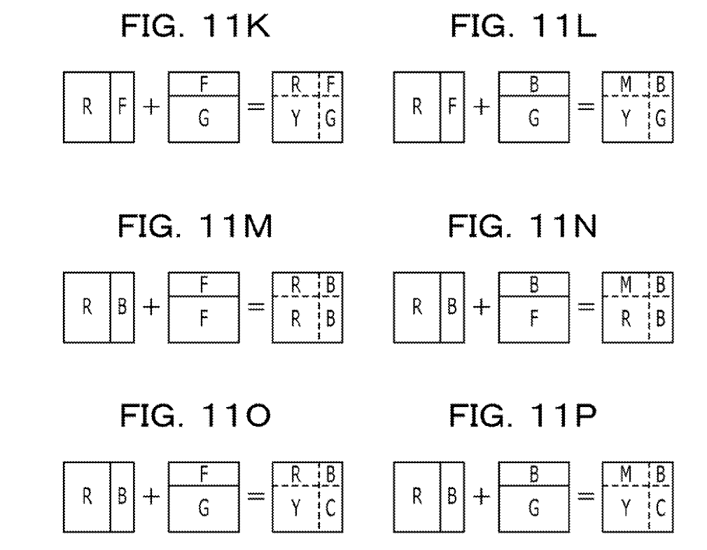

FIGS. 11A to 11P are schematic diagrams for explaining colors displayed by one pixel in which the subpixels 70A, 70B and the subpixels 69A, 69B are in the planar state and in the focal conic state, and 16 combinations are shown. FIG. 11A represents the case where all the subpixels are in the focal conic state, i.e., black, and other examples represent the cases where the subpixels are in the planar state, and reflected colors determined by stacking the panels.

Since many combinations are shown, only a few examples will be taken up. FIG. 11A represents the case where all the subpixels are in the focal conic state, and the resultant pixel displays black. In FIGS. 11B and 11E the pixel displays blue (B), in FIG. 11C the pixel displays green (G), and FIG. 11I the pixel displays red (R).

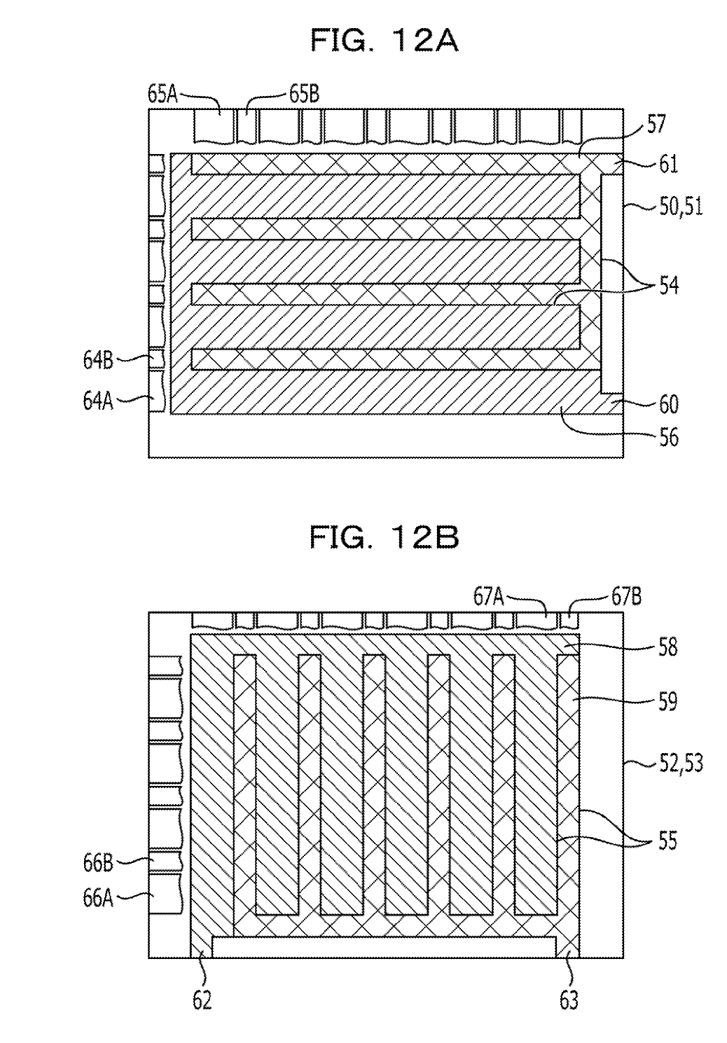

FIGS. 12A and 12B are plan views of a panel implementing a reflective color liquid crystal display element according to a second embodiment, FIG. 12A showing a first layer panel, and FIG. 12B showing a second layer panel.

In the first embodiment, the second electrode 65 and the third electrode 66 are approximately three times as wide as the first electrode 64B and the fourth electrode 67B. In other words, the second electrode 65 and the third electrode 66 are approximately 50% wider than the first electrode 64A and the fourth electrode 67A. The second embodiment is different from the first embodiment in that the second electrode 65 is divided into second electrodes 65A and 65B so as to overlap with the fourth electrodes 67A and 67B, and that the third electrode 66 is divided into third electrodes 66A and 66B so as to overlap with the first electrodes 64A and 64B, and the other portions remain unchanged.

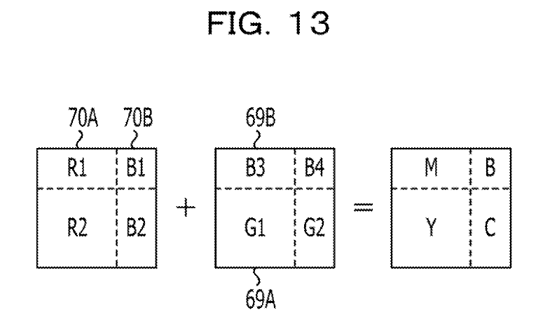

FIG. 13 is a schematic diagram showing colors of subpixels forming one pixel according to the second embodiment. Although in FIG. 13 a cholesteric liquid crystal that reflects green (G) is loaded in the first liquid crystal strips 56, a cholesteric liquid crystal that reflects blue (B) is loaded in the second liquid crystal strips 57 and the fourth liquid crystal strips 59, and a cholesteric liquid crystal that reflects red (R) is loaded in the third liquid crystal strips 58 as in FIG. 10A, it is a matter of course that different combinations may be adopted. Each subpixel may further be divided into two subpixels that may be subjected to an on/off control. For example, the subpixel 70A is divided into an upper portion R1 occupying one third and a lower portion R2 occupying two thirds of the subpixel 70A, and the portions R1 and R2 may be independently brought to the planar state or the focal conic state. Therefore, although reflecting black (F) or red (R) with the entirety of the subpixel 70A is the only choice according to the first embodiment, the one third portion or the two thirds portion may independently be made to reflect red, according to the second embodiment. Such an arrangement enables a red color to be displayed in three levels.

This is also the case with the other subpixels 68A, 68B, and 70B, and hence each of the four subpixels may display twice as many colors and resultantly one pixel may display 16 times as many colors compared with the first embodiment. Thus, according to the second embodiment, 16 times of the 16 examples shown in FIGS. 11A to 11P, i.e., 256 patterns may be realized, and therefore numerous middle tones may be displayed even by a binary on/off control of the subpixels.

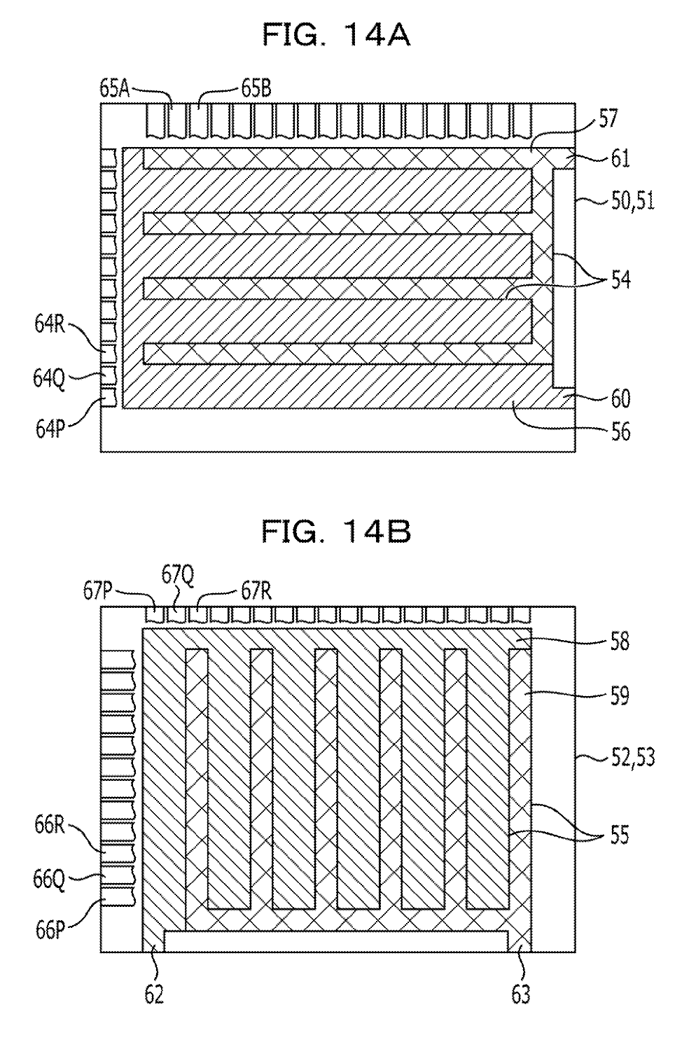

FIGS. 14A and 14B are plan views of a panel constituting a reflective color liquid crystal display element according to a third embodiment, FIG. 14A showing a first layer panel, and FIG. 14B showing a second layer panel.

In the second embodiment, the first electrode 64A, the second electrode 65A, the third electrode 66A and the fourth electrode 67A are approximately twice as wide as the first electrode 64B, the second electrode 65B, the third electrode 66B, and the fourth electrode 67B. According to the third embodiment, all the electrodes have the same width, and the other portions remain unchanged.

In the upper panel, subpixels are formed at nine intersections of adjacent first electrodes 64P, 64Q, and 64R and adjacent second electrodes 65P, 65Q, and 65R. The first electrodes 64P and 64Q are located so as to overlap with the first liquid crystal strip 56, and the first electrode 64R is located so as to overlap with the second liquid crystal strip 57. The second electrodes 65P and 65Q are located so as to overlap with the third liquid crystal strip 58 of the lower panel, and the second electrode 64R is located so as to overlap with the fourth liquid crystal strip 59 of the lower panel.

In the lower panel, subpixels are formed at nine intersections of adjacent third electrode 66P, 66Q, and 66R and adjacent fourth electrode 67P, 67Q, and 67R. The third electrode 66P and 66Q are located so as to overlap with the first liquid crystal strip 56 of the upper panel, and the third electrode 66R is located so as to overlap with the second liquid crystal strip 57 of the upper panel. The fourth electrode 67P and 67Q are located so as to overlap with the third liquid crystal strip 58, and the fourth electrode 67R is located so as to overlap with the fourth liquid crystal strip 59.

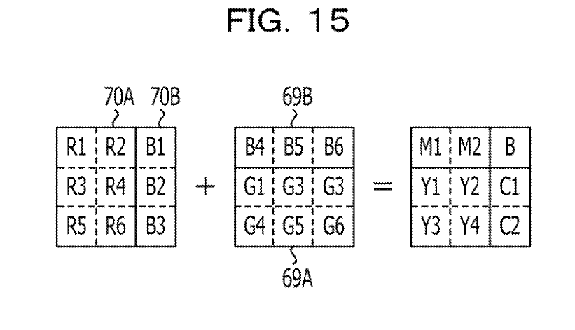

FIG. 15 is a schematic diagram showing colors of subpixels forming one pixel according to the third embodiment. Although in FIG. 15 a cholesteric liquid crystal that reflects green (G) is loaded in the first liquid crystal strips 56, a cholesteric liquid crystal that reflects blue (B) is loaded in the second liquid crystal strips 57 and the fourth liquid crystal strips 59, and a cholesteric liquid crystal that reflects red (R) is loaded in the third liquid crystal strips 58 as in FIG. 10A, it is a matter of course that different combinations may be adopted. Each subpixel may further be divided into three or more subpixels that may be subjected to an on/off control. For example, the subpixel 70A is vertically divided into three portions R1/R2 to R5/R6, and the portions R1 to R6 may be independently brought to the planar state or the focal conic state. Therefore, the patterns that may be displayed by one pixel are further increased compared with the second embodiment, specifically up to approximately 4000 patterns, and an even greater number of middle tones may be displayed even by a binary on/off control of the subpixels.

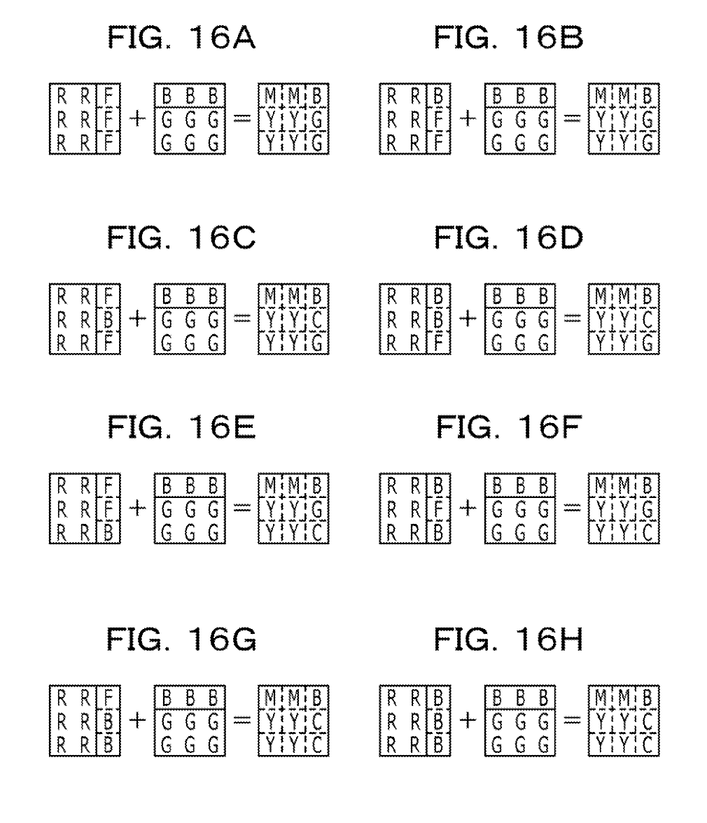

FIGS. 16A to 16H show the colors displayed by one pixel when the three portions of the subpixel 70B are made to display different colors, with the entirety of the subpixel 69A displaying green, entirety of the subpixel 69B displaying blue, and entirety of the subpixel 70A displaying red, according to the third embodiment. In this case also, 2³=8 patterns may be realized. Description of further details will be skipped.

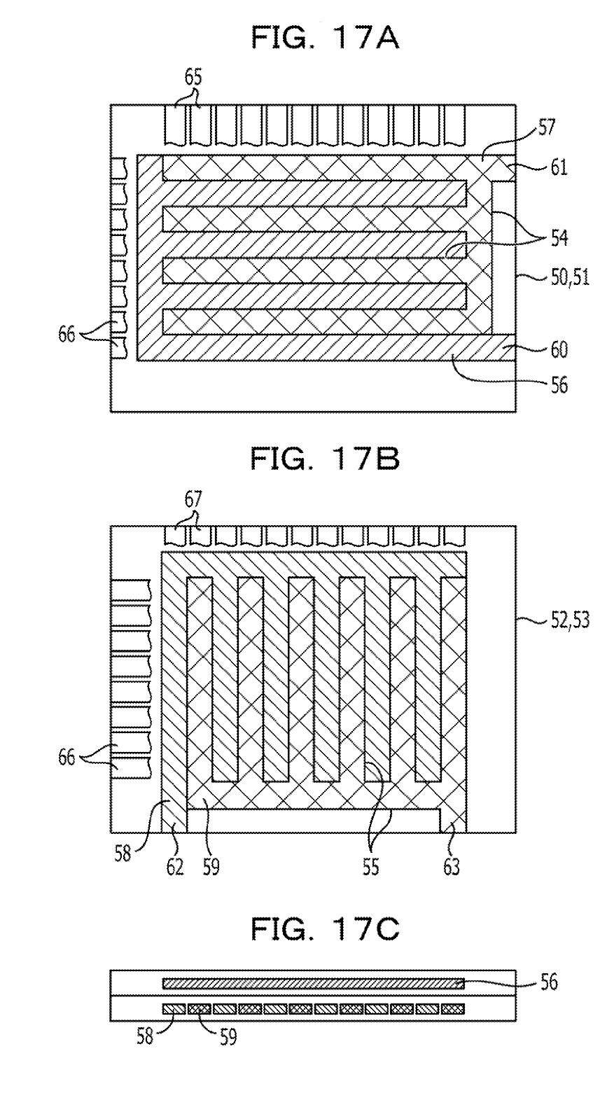

FIGS. 17A and 17B are plan views of a panel implementing a reflective color liquid crystal display element according to a fourth embodiment, and FIG. 17C is a cross-sectional view of the stacked panels.

In the first to the third embodiment, the first liquid crystal strips 56 and the third liquid crystal strips 58 are approximately twice as wide as the second liquid crystal strips 57 and the fourth liquid crystal strips 59. According to the fourth embodiment, all the liquid crystal strips have substantially the same width. Also, the first electrode 64 and the third electrode 66 are located so as to overlap with the first liquid crystal strip 56 and the second liquid crystal strip 57, and the second electrode 65 and the fourth electrode 67 are located so as to overlap with the third liquid crystal strip 58 and the fourth liquid crystal strip 59. The other portions remain unchanged compared with the first to the third embodiment.

In the fourth embodiment, four subpixels formed at positions where two adjacent first electrodes 64 and two third electrodes 66 overlapping therewith intersect with two adjacent second electrodes 65 and two fourth electrodes 67 overlapping therewith.

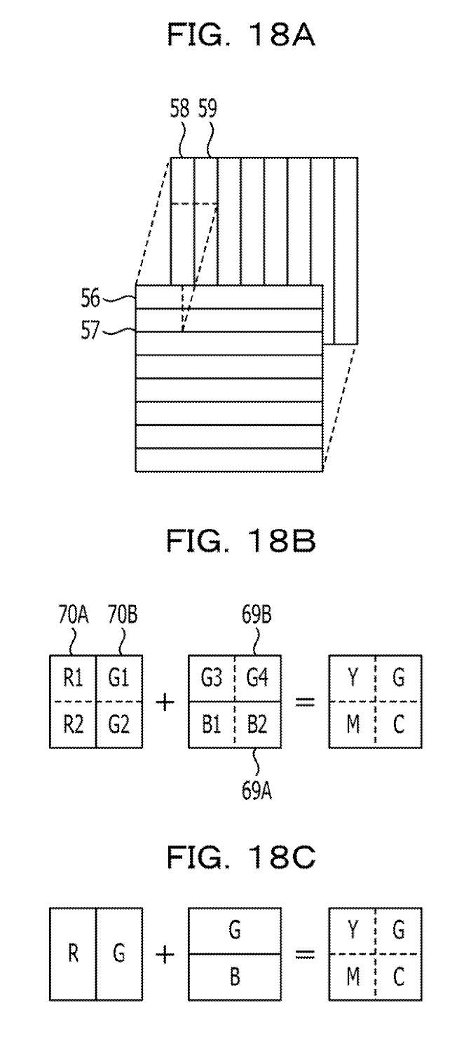

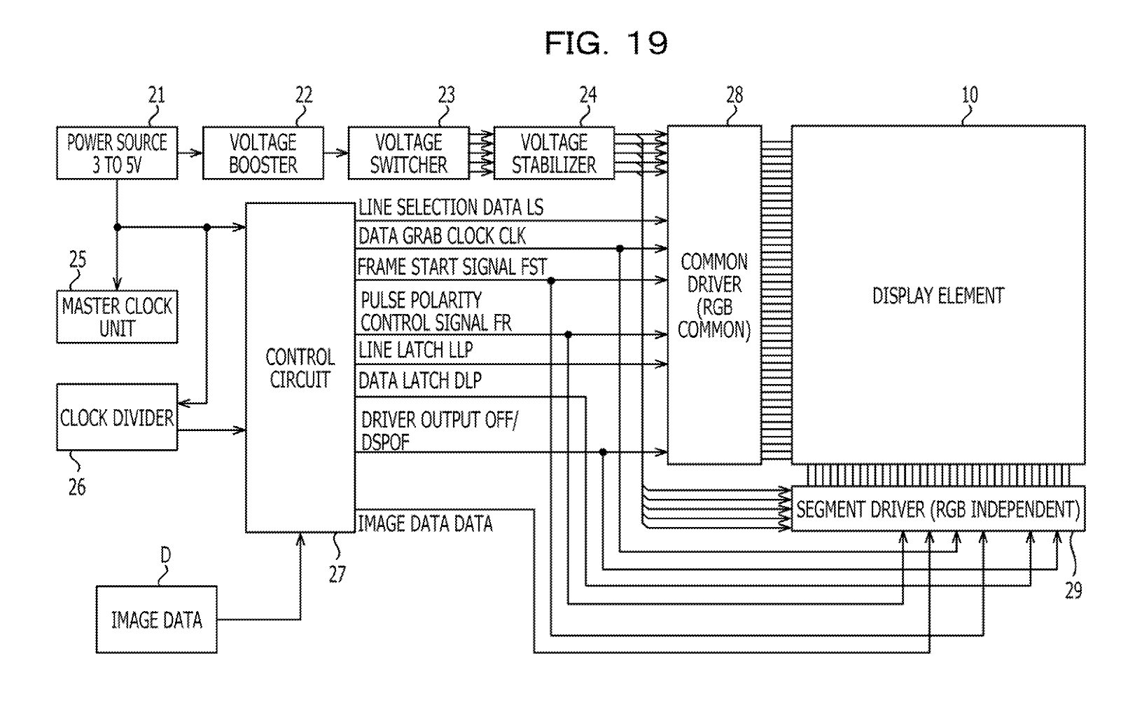

FIG. 18A depicts how the upper panel subpixels and the lower panel subpixel overlap according to the fourth embodiment. In the reflective color liquid crystal display element according to the fourth embodiment, the four liquid crystal strips namely the first liquid crystal strip 56, the second liquid crystal strip 57, the third liquid crystal strip 58, and the fourth liquid crystal strip 59 overlap as shown in FIG. 18A.

FIG. 18B is a schematic diagram showing colors of subpixels forming one pixel according to the fourth embodiment. Although in FIG. 18B a cholesteric liquid crystal that reflects green (G) is loaded in the first liquid crystal strips 56, a cholesteric liquid crystal that reflects blue (B) is loaded in the second liquid crystal strips 57, a cholesteric liquid crystal that reflects red (R) is loaded in the third liquid crystal strips 58, and a cholesteric liquid crystal that reflects green (G) is loaded in the fourth liquid crystal strips 59, it is a matter of course that different combinations may be adopted. Each subpixel may further be divided into two subpixels that may be subjected to an on/off control. The subpixel 70A is equally divided into an upper portion R1 and a lower portion R2, and the portions R1 and R2 may be independently brought to the planar state or the focal conic state. The other subpixels 69A, 69B, and 70B may also be equally divided into two portions B1 and B2, G3 and G4, and G1 and G2, respectively.

Here, the pixel is configured as shown in FIG. 18C by unifying two adjacent first electrodes 64 into a single electrode, and unifying two adjacent fourth electrode 67 into a single electrode. In this case, although the display status of the subpixels 69A, 69B, 70A, and 70B may be respectively controlled, the number of colors that may be displayed is decreased compared with the configuration shown in FIG. 18B.

In the display elements having a bilayer structure according to the first to the fourth embodiment, in which the liquid crystal strips each corresponding to one of RGB colors are provided in the upper and lower panels, it is preferable that the liquid crystal loaded in the liquid crystal strips of the respective panels presents a reverse optical rotation between the upper and lower panel. Taking the liquid crystal strips that reflect blue (B) as an example from FIG. 10A, loading an R-body B-liquid crystal which reflects a right circularly polarized light in the upper panel and loading an L-body (S-body) B-liquid crystal which reflects a left circularly polarized light may make the overlapping portions of the subpixel 69B and the subpixel 70B reflect mutually reverse circularly polarized light, thereby reducing reflection loss.

Further, it is preferable that two types of liquid crystals provided in the portions divided by the partitions in the same panel present the same optical rotation. Assuming for example that the B-liquid crystal in the second liquid crystal strip 57 (subpixel 69B) of the upper panel is an R-body and the B-liquid crystal in the fourth liquid crystal strip 59 (subpixel 70B) of the lower panel is an L-body in FIG. 10A, loading an R-body G-liquid crystal in the first liquid crystal strip 56 (subpixel 69A) of the upper panel and loading an L-body R-liquid crystal in the third liquid crystal strip 58 (subpixel 70A) of the lower panel may make the liquid crystal strips of the upper and lower panels reflect mutually reverse circularly polarized light, thereby optimizing light utilization efficiency and reducing reflection loss. Here, L-body (S-body) liquid crystals may be loaded in the liquid crystal strips of the upper panel, and R-body liquid crystals may be loaded in the liquid crystal strips of the lower panel.

The reflective color liquid crystal display elements according to the first to the fourth embodiment include the strip-shaped liquid crystal portions divided by the partitions in the respective panels, for displaying colors with the bilayer structure. In the case where the partitions extend in substantially the same direction in the upper panel and the lower panel the partitions are visibly displayed, however according to the first to the fourth embodiment the partitions in the upper panel and the lower panel are orthogonally arranged, which prevents the partitions from being prominently displayed.

Now, a reflective color liquid crystal display device that includes the reflective color liquid crystal display element according to the first to the fourth embodiment will be described hereunder.

FIG. 19 is a block diagram showing a general configuration of a reflective color liquid crystal display device including the reflective color liquid crystal display element according to one of the first to the fourth embodiment. Driving methods of the cholesteric liquid crystal display element currently known include the direct driving scheme (DDS) and the conventional driving method. Although the conventional driving method is employed in the first to the fourth embodiment, the reflective color liquid crystal display element according to these embodiments may be driven on the basis of the DDS.

The reflective color liquid crystal display device includes a display element 10, a power source 21, a voltage booster 22, a voltage switcher 23, a voltage stabilizer 24, a master clock unit 25, a frequency divider 26, a control circuit 27, a common driver 28, and a segment driver 29. The display element 10 represents the reflective color liquid crystal display element according to one of the first to the fourth embodiment.

The power source 21 outputs a voltage of, for example, 3 V to 5 V. The voltage booster 22 increases the input voltage from the power source 21 to +36 V to +40 V, utilizing a regulator such as a DC-DC converter. The voltage switcher 23 generates various voltages utilizing a resistor divider or the like. The voltage stabilizer 24 utilizes a voltage follower circuit of an operational amplifier for stabilizing the voltages supplied from the voltage switcher 23.

The master clock unit 25 generates a basic clock that serves as the basis of operation. The frequency divider 26 divides the frequency of the basic clock to thereby generate various clocks for operations to be subsequently described.

The display element 10 includes three cholesteric liquid crystal panels, respectively corresponding to each of RGB, stacked on each other for color display and is, for example, an XGA liquid crystal of A4 size having 1024×768 pixels. The display element 10 includes 1024 data electrodes and 768 scan electrodes, and the segment driver 29 drives the 1024 data electrodes and the common driver 28 drives the 768 scan electrodes, respectively. Since different RGB image data is given to each pixel, the segment driver 29 independently drives each of the data electrodes. The common driver 28 collectively drives the scan electrodes for RGB. To drive the display element according to the first embodiment for example, the first electrodes 64A, 64B and the third electrode 66 are driven as the scan electrodes, and the second electrode 65 and the fourth electrode 67A, 67B are driven as the data electrodes.

A general-purpose STN driver that may operate as the common driver or segment driver upon selecting an operation mode is currently available. In the foregoing embodiments, the general-purpose STN driver is employed as the common driver 28 and the segment driver 29. For use as the segment driver 29, the STN driver is set to operate in a segment mode, for normal operation. For use as the common driver 28, the STN driver is normally set to operate in a common mode, however in the foregoing embodiments the STN driver is set to operate as the segment driver. In the first embodiment, to utilize the general-purpose STN driver as the common driver under the setting for operation as the segment driver, a part of a source voltage to be supplied to the segment driver 29 is shifted to be supplied to the common driver 28 as a source voltage.

The control circuit 27 generates a control signal on the basis of the basic clock, other clocks and image data D, and provides the control signal to the common driver 28 and the segment driver 29. A line selection data LS is a 2-bit signal instructing the common driver 28 to which scan line a preparation pulse, a selection pulse and an evolution pulse are to be applied. Image data DATA instructs the segment driver 29 whether to apply a voltage specified for white display or for black display to each data electrode. A data grab clock CLK serves as the basis for the common driver 28 and the segment driver 29 to internally transfer the line selection data and the image data. A frame start signal FST instructs to start data transfer for a display screen to be rewritten, and the common driver 28 and the segment driver 29 reset the internal status in accordance with the frame start signal FST. A pulse polarity control signal FR is a polarity reversal signal for inverting an applied voltage halfway of writing one line. The common driver 28 and the segment driver 29 reverse the polarity of the signal to be outputted, in accordance with the pulse polarity control signal FR. A line latch LLP instructs the common driver 28 to finish transferring the line selection data, and latches the line selection data transferred in accordance with this signal. A data latch signal DLP instructs the segment driver 29 to finish transferring the image data, and latches the image data transferred in accordance with this signal. A driver output off signal/DSPOF is a compulsory off signal of an applied voltage.

The operation of the common driver 28 and the segment driver 29, as well as the signal provided thereto may be similar to those popularly known.

In the foregoing embodiments a plurality of subpixels on two panels implement one pixel, and a color display control and middle tone control have to be performed in consideration of colors that may be displayed by each of the subpixels. However, since such an image display control may be performed by known methods obvious to those skilled in the art, no further description will be made.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments of the present inventions have been described in detail, it should be understood that the various changes, substitutions, and alterations could be made hereto without departing from the spirit and scope of the invention.

What is claimed is:

1. A liquid crystal display element comprising:
a first liquid crystal layer and a second liquid crystal layer stacked on each other;
the first liquid crystal layer includes a first liquid crystal strip group and a second liquid crystal strip group extending in a first direction and alternately aligned, and a first electrode group and a second electrode group disposed so as to hold the first liquid crystal strip group and the second liquid crystal strip group therebetween;
the second liquid crystal layer includes a third liquid crystal strip group and a fourth liquid crystal strip group extending in a second direction orthogonal to the first direction and alternately aligned, and a third electrode group and a fourth electrode group disposed so as to hold the third liquid crystal strip group and the fourth liquid crystal strip group therebetween;
the first electrode group includes a plurality of first electrodes extending in the first direction substantially parallel to each other;
the second electrode group includes a plurality of second electrodes extending in the second direction substantially parallel to each other;
the third electrode group includes a plurality of third electrodes extending in the first direction substantially parallel to each other; and
the fourth electrode group includes a plurality of fourth electrodes extending in the second direction substantially parallel to each other.

2. The liquid crystal display element according to claim 1,
wherein the first liquid crystal strip group changes its reflectance for light that exhibits a first color in accordance with an applied voltage;
the second liquid crystal strip group changes its reflectance for light that exhibits a second color in accordance with an applied voltage, the second color being different from the first color;
the third liquid crystal strip group changes its reflectance for light that exhibits a third color in accordance with an applied voltage; and
the fourth liquid crystal strip group changes its reflectance for light that exhibits a fourth color in accordance with an applied voltage, the fourth color being different from the third color.

3. The liquid crystal display element according to claim 2,
wherein at least one of the first color and the second color and one of the third color and the fourth color are substantially the same.

4. The liquid crystal display element according to claim 3,
wherein the first to the fourth colors are one of red, green, and blue.

5. The liquid crystal display element according to claim 1,
wherein the first liquid crystal strip and the second liquid crystal strip have different widths; and
the third liquid crystal strip and the fourth liquid crystal strip have different widths.

6. The liquid crystal display element according to claim 5,
wherein the narrower one of the first liquid crystal strip and the second liquid crystal strip exhibits a color of a lower visual impression than the other one.

7. The liquid crystal display element according to claim 6,
wherein the narrower one of the first liquid crystal strip and the second liquid crystal strip reflects blue.

8. The liquid crystal display element according to claim 5,
wherein one of the first liquid crystal strip and the second liquid crystal strip is twice as wide as the other.

9. The liquid crystal display element according to claim 1,
wherein the plurality of first electrodes, the plurality of second electrodes, the plurality of third electrodes and the plurality of fourth electrodes have substantially the same width; and
the width of the electrodes corresponds to a width of the narrowest one of the first to the fourth liquid crystal strip.

10. The liquid crystal display element according to claim 1,
wherein the first electrode group includes a first electrode strip group disposed so as to correspond to the first liquid crystal strip group, and a second electrode strip group disposed so as to correspond to the second liquid crystal strip group;
the fourth electrode group includes a third electrode strip group disposed so as to correspond to the third liquid crystal strip group, and a fourth electrode strip group disposed so as to correspond to the fourth liquid crystal strip group;
each first electrode strip of the first electrode strip group has a width corresponding to that of the first liquid crystal strip;
each second electrode strip of the second electrode strip group has a width corresponding to that of the second liquid crystal strip;
each third electrode strip of the third electrode strip group has a width corresponding to that of the third liquid crystal strip; and
each fourth electrode strip of the fourth electrode strip group has a width corresponding to that of the fourth liquid crystal strip.

11. The liquid crystal display element according to claim 1,
wherein the second electrode group includes a third counter electrode group disposed so as to correspond to the third liquid crystal strip group, and a fourth counter electrode group disposed so as to correspond to the fourth liquid crystal strip group;
each third counter electrode of the third counter electrode group has a width corresponding to that of the third liquid crystal strip;
each fourth counter electrode of the fourth counter electrode group has a width corresponding to that of the fourth liquid crystal strip.

12. The liquid crystal display element according to claim 1,
wherein a liquid crystal included in the first and the second liquid crystal strip group of the first liquid crystal layer, and a liquid crystal included in the third and the fourth liquid crystal strip group of the second liquid crystal layer present the same optical rotation.

13. The liquid crystal display element according to claim 3,
wherein a liquid crystal included in the liquid crystal strip group of the first liquid crystal layer and a liquid crystal included in the liquid crystal strip group of the second liquid crystal layer that exhibits the same color as the former liquid crystal strip group present different optical rotations.

14. The liquid crystal display element according to claim 1,
wherein a liquid crystal included in the first and the second liquid crystal strip group of the first liquid crystal layer, and in the third and the fourth liquid crystal strip group of the second liquid crystal layer is a cholesteric liquid crystal.

15. A liquid crystal display device comprising:
a liquid crystal display element including:
a first liquid crystal layer and a second liquid crystal layer stacked on each other;
wherein the first liquid crystal layer includes a first liquid crystal strip group and a second liquid crystal strip group extending in a first direction and alternately aligned, and a first electrode group and a second electrode group disposed so as to hold the first liquid crystal strip group and the second liquid crystal strip group therebetween;
the second liquid crystal layer includes a third liquid crystal strip group and a fourth liquid crystal strip group extending in a second direction orthogonal to the first direction and alternately aligned, and a third electrode group and a fourth electrode group disposed so as to hold the third liquid crystal strip group and the fourth liquid crystal strip group therebetween;
the first electrode group includes a plurality of first electrodes extending in the first direction substantially parallel to each other;
the second electrode group includes a plurality of second electrodes extending in the second direction substantially parallel to each other;
the third electrode group includes a plurality of third electrodes extending in the first direction substantially parallel to each other; and
the fourth electrode group includes a plurality of fourth electrodes extending in the second direction substantially parallel to each other;
a first driver that drives the plurality of first electrodes and the plurality of third electrodes; and
a second driver that drives the plurality of second electrodes and the plurality of fourth electrodes.

16. The liquid crystal display device according to claim 15,
wherein an intersection where a set of the first liquid crystal strip and the second liquid crystal strip adjacent to each other intersects with a set of the third liquid crystal strip and the fourth liquid crystal strip adjacent to each other implements one pixel, in plan view of the liquid crystal display element.

17. The liquid crystal display element according to claim 6,
wherein the narrower one of the third liquid crystal strip and the fourth liquid crystal strip exhibits a color of a lower visual impression than the other one.

18. The liquid crystal display element according to claim 17,
wherein the narrower one of the third liquid crystal strip and the fourth liquid crystal strip reflects blue

19. The liquid crystal display element according to claim 8,
wherein one of the third liquid crystal strip and the fourth liquid crystal strip is twice as wide as the other.

20. The liquid crystal display element according to claim 11,
wherein the third electrode group includes a first counter electrode group disposed so as to correspond to the first liquid crystal strip group, and a second counter electrode group disposed so as to correspond to the second liquid crystal strip group;
each first counter electrode of the first counter electrode group has a width corresponding to that of the first liquid crystal strip; and
each second counter electrode of the second counter electrode group has a width corresponding to that of the second liquid crystal strip.
